(19) United States
(12) Patent Application Publication
(10) Pub. No.: US 2016/0017785 A1
(43) Pub. Date: Jan. 21, 2016

(54) STATIC MIXER

(71) Applicant: Eberspacher Exhaust Technology GmbH & Co. KG, Neunkirchen (DE)

(72) Inventors: Andreas RESCH, Boblingen (DE); Silvia CALVO, Esslingen (DE)

(21) Appl. No.: 14/798,793

(22) Filed: Jul. 14, 2015

(30) Foreign Application Priority Data
Jul. 15, 2014 (DE) 10 2014 213 746.2

(51) Int. Cl. F01N 3/28; B01F 5/06; F01N 3/20

(52) U.S. Cl. CPC F01N 3/2892; F01N 3/2066; B01F 5/0602

(57) ABSTRACT

A static mixer (12) for an exhaust system (7) for mixing a reducing agents with an exhaust gas flow (8). The static mixer (12) has a plurality of guide blades (14) for deflecting the exhaust gas flow (8). A reduced flow resistance is obtained when at least one of the guide blades (14) has a perforation (25) through which the exhaust gas flow (8) can flow.

### CROSS REFERENCE TO RELATED APPLICATIONS

This application claims the benefit of priority under 35 U.S.C. §119 of German Patent DE 10 2014 213 746.2 filed Jul. 15, 2014, the entire contents of which are incorporated herein by reference.

### FIELD OF THE INVENTION

The present invention pertains to a static mixer for an exhaust system for mixing a reducing agent with an exhaust gas flow. The present invention also pertains to an exhaust system equipped with such a mixer.

### BACKGROUND OF THE INVENTION

In exhaust systems of internal combustion engines there is in certain applications the need to introduce a reducing agent into the exhaust gas flow. For example, a fuel can be introduced into the exhaust gas flow upstream of an oxidation catalytic converter in order to increase the heat of the exhaust gas flow due to a reaction of the fuel in the oxidation catalytic converter, for example, in order to heat up a particle filter that is arranged downstream to its regeneration temperature. It is likewise common in SCR systems to introduce an aqueous urea solution upstream of an SCR catalytic converter into the exhaust gas flow, whereby SCR denotes Selective Catalytic Reaction. The aqueous urea solution can be converted by means of thermolysis and hydrolysis into ammonia and carbon dioxide, which makes a conversion of nitrogen oxides into nitrogen and water possible in the SCR catalytic converter.

In order to optimize the respective reaction, which shall be brought about with the reducing agent introduced, it is of high importance to mix the introduced reducing agent with the exhaust gas flow as homogeneously as possible. Frequently, the reducing agent is introduced in liquid form into the exhaust gas flow, such that it is also necessary to evaporate the reducing agent as completely as possible. A static mixer mentioned in the introduction, which brings about an intense mixing of exhaust gas and reducing agent, is used for this purpose.

A static mixer, which has a plurality of guide blades for deflecting the exhaust gas flow, is known from EP 1 985 356 A2. For this purpose, the guide blades project into the exhaust gas flow and are set towards the exhaust gas flow in order to be able to bring about the respective deflection of the exhaust gas flow. As a result of this, the guide blades at the same time form impact areas for the reducing agent introduced in liquid form. Due to the impact of the guide blades with the exhaust gas flow, these guide blades have a relatively high temperature, such that the guide blades at the same time are used as evaporation surfaces for reducing agent deposited thereon.

An as large as possible impact surface, on the one hand, and an as intensive as possible deflection of the flow, on the other hand, result each in an increased flow resistance of the mixer. The flow resistance of the mixer brings about a rise in pressure in the exhaust system upstream of the mixer, which reduces the efficiency of an internal combustion engine equipped with the exhaust system or increases its fuel consumption.

### SUMMARY OF THE INVENTION

An object of the present invention is to provide an improved embodiment for a static mixer of the type mentioned above or for an exhaust system equipped therewith, which is characterized especially by a comparatively low flow resistance, while at the same time a sufficient mixing and especially a sufficient evaporation can be achieved.

According to the invention, a static mixer is provided comprising a plurality of guide blades for deflecting the exhaust gas flow. At least one of the guide blades comprises a perforation through which the exhaust gas flows.

According to another aspect of the invention, an exhaust system is provided for an internal combustion engine. The exhaust system comprises an injector for introducing a liquid reducing agent into an exhaust gas flow and at least one static mixer arranged downstream of the injector with regard to the exhaust gas flow. The static mixer comprises a plurality of guide blades for deflecting the exhaust gas flow. At least one of the guide blades comprises a perforation through which the exhaust gas flows.

The present invention is based on the general idea of equipping at least one of the guide blades, and preferably all guide blades, each with a perforation, through which the exhaust gas, i.e., a part of the exhaust gas flow, can flow. It has been shown that such a perforation can significantly reduce the flow resistance of the mixer, whereby at the same time turbulence is sufficiently generated by the perforation to bring about the desired intensive mixing.

In the present context, a perforation is defined as any interruption of a structure of the guide blade that is otherwise closed or impermeable to exhaust gas. Thus, openings, through holes, tiltings and the like are perforations.

The perforation of the respective guide blade may in this case have a plurality of passage openings which are each arranged within a lateral outer contour of the respective guide blade according to a preferred embodiment. Thus, the respective guide blade has an outer contour which is not compromised by the passage openings. In this way, the flow-guiding function of the respective guide blades is only comparatively slightly compromised by the perforation.

According to an advantageous variant, the passage openings may have a round or an angular cross section. Likewise, the passage openings may have a punctiform or else an oblong cross section. Passage openings with oblong cross section may be linear or single-curved or multi-curved.

In another advantageous variant, the passage openings may each have an oblong cross section and be arranged parallel to each other and next to each other along a blade length measured from a blade footing to a blade tip of the respective guide blade. In such an embodiment, a low flow resistance can be shown for the respective guide blade with sufficient or improved mixing effect.

According to a variant, the passage openings may be arranged with their oblong cross sections sloped toward the blade length and sloped toward a blade width measured from a leading edge to a discharge edge of the respective guide blade. By means of this measure, the mixing effect can, in addition, be affected and optimized.

According to another embodiment, the perforation may have at least one or a plurality of passage openings, which are open on the side at a discharge edge or at a leading edge of the respective guide blade. In this embodiment, these passage openings open on the side have an effect on a lateral outer contour of the respective guide blade. For example, targeted flow separations and swirl may be generated thereby, which may have advantageous effects on an intensive mixing. All the passage openings of the perforation are preferably open on the side at the discharge edge or at the leading edge. However, an embodiment, in which the perforation has at least one open passage opening on the outer contour of the guide blade and at least one passage opening lying completely within the outer contour, is also generally conceivable.

In a variant which assumes that a plurality of passage openings open on the side are provided, the passage openings open on the side may be oblong and be sloped towards a blade length of the guide blade as well as towards a blade width of the guide blade. As before, the blade length extends from a blade footing up to a blade tip, while the blade width extends from the leading edge to the discharge edge.

In another variant, the passage openings open on the side of the leading edge may be sloped with regard to the blade length opposed to the passage openings of the discharge edge. As a result of this, the flow-conducting action of the guide blades can be optimized with regard to an improved mixing.

In an alternative embodiment the perforation in at least one of the guide blades may be formed from a single passage opening. Such a singular passage opening is advantageously dimensioned larger in terms of its flow cross section than the individual passage openings of the perforations explained above, which are formed by a plurality of passage openings. Accordingly, such a perforation has a reduced flow resistance.

This singular passage opening may be arranged within a lateral outer contour of the respective guide blade in one variant. In other words, an embodiment, in which the passage opening does not have an effect on the outer contour of the guide blade, is preferred here as well. It can essentially extend from a blade footing up to a blade tip as well. Further, the passage opening may have a pointed design, whereby the tip of the passage opening can then be arranged in the area of the blade tip. As an alternative, the passage opening may also be provided with a constant width.

Basically, it is likewise possible to develop the singular passage opening open on the side on a blade tip of the respective guide blade. If this singular passage opening open on one side is, in addition, designed as oblong, quasi a division of the guide blade in the area of the passage opening can thus be achieved. Such a passage opening, open in the area of the blade tip, may lead to an especially low flow resistance in the area of the respective guide blade.

In another advantageous embodiment the respective guide blade may have a single- or multi-curved course along its blade length. While the guide blades usually have a linear design, it is suggested here now to equip the respective guide blade with a curved course with regard to its central longitudinal axis. The central longitudinal axis of the respective guide blade extends thereby from the blade footing to the blade tip approximately in the center with regard to the blade width. A single-curved guide blade then has a sickle-shaped design. A twice-curved guide blade then has an S-shaped design. In addition or as an alternative, the respective guide blade may have a twisting with regard to its central longitudinal axis, which leads to a varying pitch angle along the blade length.

In another advantageous embodiment, the mixer may have a cylindrical pipe body, which encloses a flow cross section through which the exhaust gas flow can flow in the circumferential direction and from which the guide blades project inwards. In this type of construction, the guide blades may be especially arranged detached radially inwards in the area of their blade tips. Furthermore, the guide blades may be arranged in a contactless manner relative to each other.

Especially advantageous is a variant, in which the pipe body with all guide blades is produced from a single sheet metal body by means of shaping. As a result of this, the mixer can be produced at a comparatively low cost by means of punching and shaping processes.

In another advantageous embodiment, the perforation may have at least one passage opening with an opening edge, which is detached along its entire circulation. Such a detached opening edge may be produced by a punching process in an especially simple manner in case of a guide blade designed as a sheet metal body. Preferably, the circulation is completely closed, when the respective passage opening is arranged within the outer contour of the guide blade. If, on the other hand, the passage opening is designed open on the side on the outer contour of the guide blade, the circulation of the opening edge on the outer contour is interrupted.

Advantageously, all passage openings of the respective guide blade are equipped with such a detached opening edge.

In another embodiment, the perforation may have at least one passage opening with an opening edge, which is connected with a tilting device (angled feature) along a circulation section. The tilting device may at least partly cover the associated passage opening. In addition or as an alternative, the tilting device may be sloped towards an area of the guide blade adjacent thereto. In addition or as an alternative, the tilting device may be arranged at least partly offset towards an area of the guide blade adjacent thereto. The arrangement of the tilting device is thereby preferred, such that the tilting device at least partly covers the passage opening and accordingly brings about a flow deflection of an exhaust gas flow passing through the passage opening. Such a tilting device at the opening edge of the passage opening improves the mixing action of the guide blade. At the same time, the flow resistance can be reduced by the flow deflection with the tilting device.

The tilting device is advantageously formed integrally in one piece with the respective guide blade. The respective tilting device can especially advantageously be an area of the respective guide blade that is free-cut and tilted for producing the respective passage opening. Thus, the respective guide blade can be equipped in an especially simple manner with the passage openings and tilting devices adjacent thereto.

According to an advantageous variant, provisions may be made for at least one such tilting device to have a central area and two lateral areas, whereby the central area extends essentially parallel to the respective guide blade and is connected with the respective guide blade via the two lateral areas. As a result of this, an especially efficient covering of the respective passage opening is obtained.

Further, according to another variant, provisions may be made for at least one such tilting device to be designed as a wing, which is connected only on one side with the respective guide blade and is otherwise arranged detached to the respective guide blade. Such a wing acts as a flow-guiding element, such that the flow of the respective passage opening can be especially favorably affected by means of such a wing.

In addition, provisions may advantageously be made for at least one such tilting device to be formed by a step, which is spaced apart in a blade longitudinal direction from a (different) step formed in the respective guide blade. The respective step may be produced by means of bending the guide blade twice, preferably by approx. 90°, transversely to its longitudinal direction.

It is clear that the different variants mentioned above for the perforation—insofar as useful—can be achieved at at least one single guide blade or in case of various guide blades of the same mixer, i.e., especially passage openings of different sizes and/or geometries and/or with or without tilting devices.

The mixer presented here is heated exclusively by the exhaust gas flow during the operation of the exhaust system, such that it operates free from external energy with regard to its evaporation action.

In an exhaust system according to the present invention, which is suitable for discharging combustion waste gases in an internal combustion engine, an injector is provided for introducing a liquid reducing agent into the exhaust gas flow, whereby, in addition, at least one mixer of the type described above is arranged downstream of this injector with regard to the exhaust gas flow. The exhaust system may, furthermore, have an SCR catalytic converter downstream of the mixer or an oxidation catalytic converter downstream of the mixer.

Further important features and advantages of the present invention appear from the subclaims, from the drawings and from the associated description of the figures based on the drawings.

It is apparent that the features mentioned above and those still to be explained below can be used not only in the respective given combination, but also in other combinations or alone, without going beyond the scope of the present invention.

Preferred exemplary embodiments of the present invention are shown in the drawings and are explained in detail in the following description, whereby identical reference numbers refer to identical or similar or functionally identical components. The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which preferred embodiments of the invention are illustrated.

### BRIEF DESCRIPTION OF THE DRAWINGS

FIG. 1 is a circuit-diagram-like schematic diagram of an internal combustion engine with an exhaust system, which contains a static mixer;

FIG. 2 is an isometric view of the mixer;

FIG. 3 is an axial view of the mixer;

FIG. 4 is a layout of the mixer;

FIG. 5 is a simplified view of a guide blade of the mixer in one of various embodiments;

FIG. 6 is a simplified view of a guide blade of the mixer in another of various embodiments;

FIG. 7 is a simplified view of a guide blade of the mixer in another of various embodiments;

FIG. 8 is a simplified view of a guide blade of the mixer in another of various embodiments;

FIG. 9 is a simplified view of a guide blade of the mixer in another of various embodiments;

FIG. 10 is a simplified view of a guide blade of the mixer in another of various embodiments;

FIG. 11 is a simplified view of a guide blade of the mixer in another of various embodiments;

FIG. 12 is a simplified view of a guide blade of the mixer in another of various embodiments;

FIG. 13 is a simplified view of a guide blade of the mixer in another of various embodiments;

FIG. 14 is a simplified view of a guide blade of the mixer in one of various embodiments and partly with associated sectional view or variant A;

FIG. 15 is a simplified view of a guide blade of the mixer in another of various embodiments and partly with associated sectional views or variants A, B and C;

FIG. 16 is a simplified view of a guide blade of the mixer in another of various embodiments;

FIG. 17A is a simplified view of another embodiment of a guide blade of the mixer;

FIG. 17B is a simplified view of another embodiment of a guide blade of the mixer;

FIG. 17C is a simplified view of another embodiment of a guide blade of the mixer;

FIG. 17D is a simplified view of another embodiment of a guide blade of the mixer;

FIG. 18 is a simplified view of a guide blade of the mixer in another of various embodiments;

FIG. 19 is a simplified view of a guide blade of the mixer in another of various embodiments and partly with associated sectional views or variants A and B; and

FIG. 20 is an isometric view of a guide blade of the mixer from FIG. 19 in the area of a perforation.

### DESCRIPTION OF THE PREFERRED EMBODIMENTS

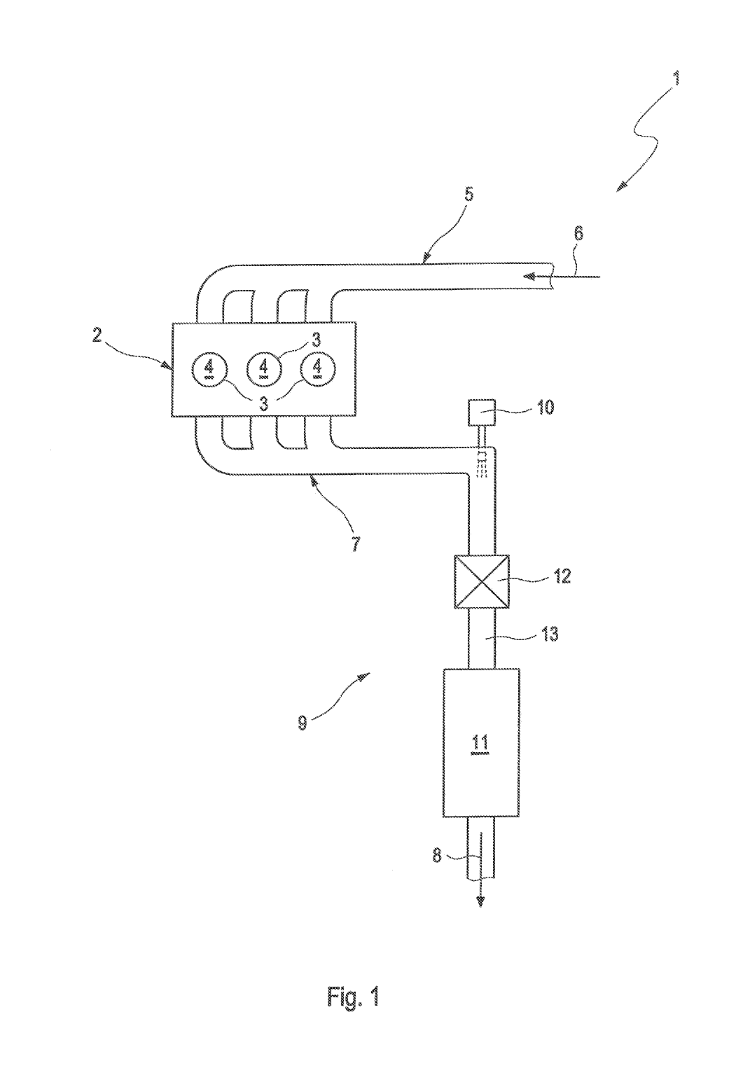

Referring to the drawings, according to FIG. 1, an internal combustion engine 1 comprises an engine block 2 which contains a combustion chamber 4 each in a plurality of cylinders 3. Pistons, which are not shown here, are arranged with adjustable stroke in the cylinders 3, such that the internal combustion engine 1 is a piston engine. A fresh air feed unit 5 is provided for supplying the combustion chambers 4 with fresh air. A corresponding fresh air flow 6 is indicated by an arrow. In order to be able to discharge combustion gases from the combustion chambers 4, the internal combustion engine is, in addition, equipped with an exhaust system 7. An exhaust gas flow 8 is indicated by an arrow. In the example of FIG. 1, the exhaust system 7 is equipped with an SCR system 9, which has an injector for introducing a liquid reducing agent into the exhaust gas flow 8, an SCR catalytic converter 11 for reducing nitrogen oxides with the aid of the previously injected reducing agent as well as a static mixer 12. With regard to the flow direction of the exhaust gas flow 8, the SCR catalytic converter 11 is arranged downstream of the injector 10. Further, the mixer 12, with regard to the direction of flow of the exhaust gas flow 8, is arranged downstream of the injector 10 and upstream of the SCR catalytic converter 11. The exhaust system 7 has an exhaust line 13, into which the above-mentioned components of the SCR system 9 are integrated.

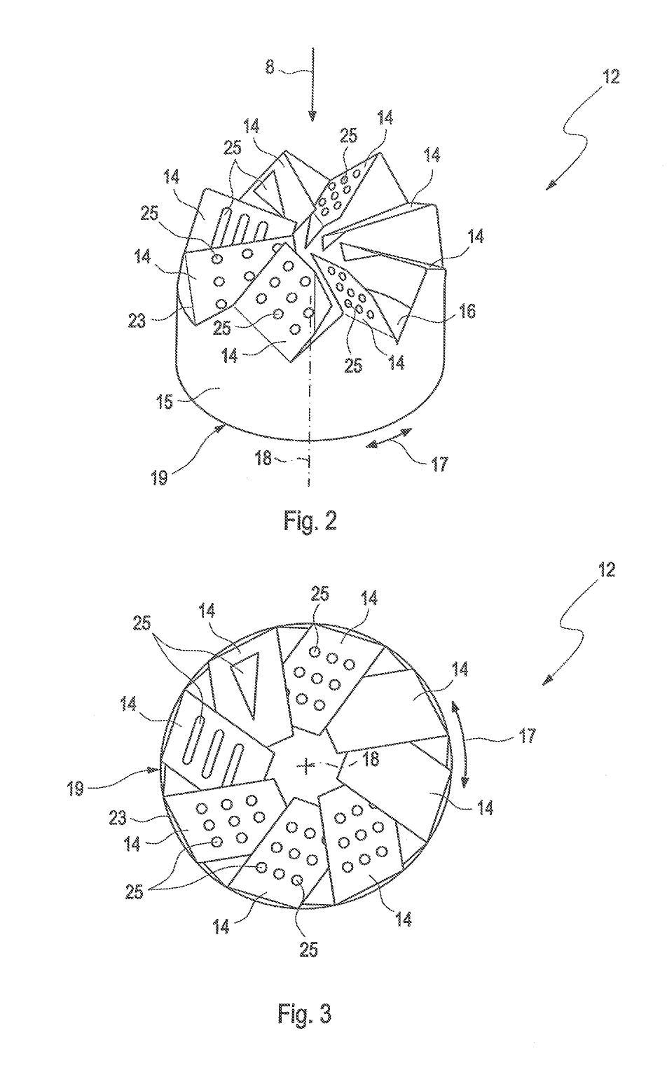

According to FIGS. 2 and 3, the mixer 2 has a plurality of guide blades 14 which are each used for deflecting the exhaust gas flow 8. In the preferred example shown the mixer 12 has, moreover, a cylindrical pipe body 15, which encloses a flow cross section 16, through which the exhaust gas flow 8 can flow, in the circumferential direction 17. The circumferential direction 17 is in reference to a central longitudinal axis 18 of the pipe body 15 or of the mixer 12. The guide blades 14 project from the pipe body 15 inwards, i.e., in the direction of the central longitudinal axis 18. Thereby, the direction of extension of the respective guide blade 14 has at least one radial component. Further, this direction of extension may optionally also have an axial component.

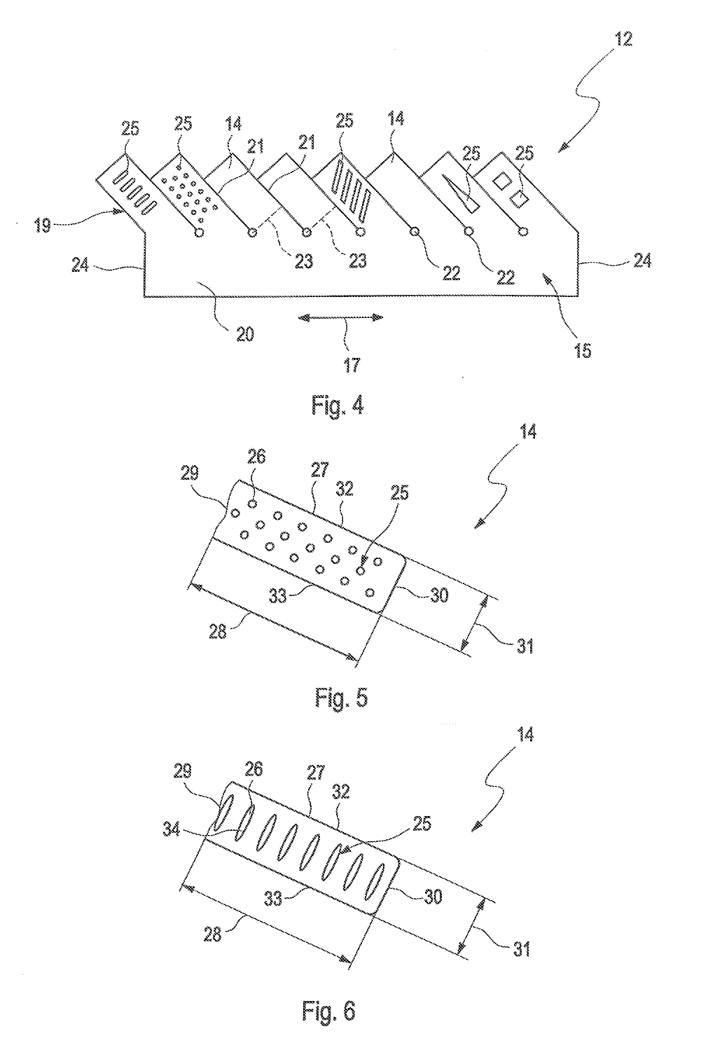

Advantageously, this pipe body is produced integrally with the guide blades 14 from a single sheet metal body 19, namely by means of shaping, such that the mixer 12 is ultimately a single shaped sheet metal part. A layout of the sheet metal body 19 or of the mixer 12 is shown in FIG. 4. The sheet metal body 19 has a jacket section 20, which forms the pipe body 15 in the shaped state. The guide blades 14 project from this jacket section 20. In the layout of FIG. 4, the individual guide blades 14 are already free-cut, whereby individual sections are designated with 21. The sections 21 pass over at the jacket section 20 into round holes 22 to avoid a tear formation at this passing over.

In order to produce the mixer 12 from the planar sheet metal body 19 in FIG. 4, the blades 14 are each bent over a bending edge 23 and the jacket section 20 is bent over the central longitudinal axis 18 of the mixer 12 in the circumferential direction 17. Thereby, the longitudinal ends 24 of the jacket section 20 may form a butt joint at the pipe body 15 in the circumferential direction 17 and be fastened to each other.

As can be inferred from FIGS. 2 through 4, the guide blades 14 in the example shown of the mixer 12 are exclusively designed on a leading side of the pipe body 15. For orientation, the exhaust gas flow 8 is indicated by a flow arrow. Likewise, an embodiment is conceivable, in which all guide blades 14 are arranged on a discharge side of the pipe body 15. Further, it is conceivable to provide such guide blades 14 at the pipe body 15 both on the leading side and on the discharge side each. The use of two mixers 12, which are arranged one behind the other in the direction of flow of the exhaust gas flow 8, is also conceivable.

As can be inferred from FIGS. 2 through 4, at least one of the guide blades 14 is equipped with a perforation 25. The perforation 25 is thereby configured, such that the perforation 25 traverses the otherwise closed guide blade 14, such that the exhaust gas flow 8 or partial flows of the exhaust gas flow 8 can flow through the guide blade 14 through the respective perforation 25. Even though not all guide blades 14 are equipped with such a perforation 25 in the examples of FIGS. 2 through 4, an embodiment is, however, preferred, in which all of the guide blades 14 have such a perforation 25. Even though various perforations 25 are provided in the individual guide blades 14 in FIGS. 2 through 4, an embodiment is preferred, in which the perforated blades 14 have an identical perforation 25 each.

Various embodiments of such a perforation 25 are explained in detail below based on FIGS. 5 through 20. For example, the respective perforation 25 may have a plurality of passage openings 26, which are arranged within a lateral outer contour 27 of the respective guide blade 14. FIGS. 5 through 10, 15 and 18 show embodiments, in which all passage openings 26 of the perforation 25 are arranged within the outer contour 27 of the guide blade 14. In the embodiment shown in FIG. 5, all passage openings 26 are equipped with a round and punctiform cross section. In particular, the passage openings 26 show each a round cross section.

In the embodiment shown in FIG. 6, the passage openings 26 are designed as oblong and linear. Further, they extend parallel to each other. Furthermore, the parallel arranged passage openings 26 are arranged next to each other along a blade length 28. The blade length 28 is thereby measured from a blade footing 29 up to a blade tip 30. In a mixer according to the embodiment shown in FIGS. 2 through 4, the blade footing is arranged at the pipe body 15, while the blade tip 30 is arranged detached in the area of the central longitudinal axis 18.

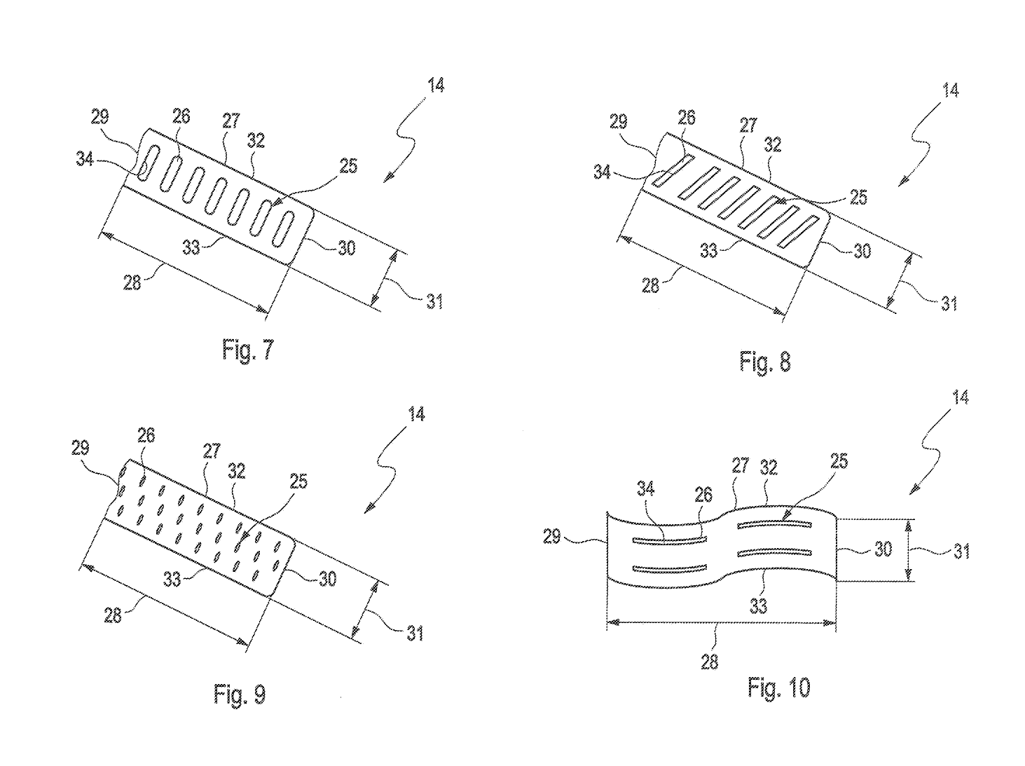

The embodiment shown in FIG. 7 corresponds to the embodiment shown in FIG. 6, providing that the passage openings 26 have different cross sections. On the other hand, FIG. 8 shows an embodiment, in which the oblong passage openings 26 have an angular, in this case parallelogram-like cross section. Further, the passage openings 26 are arranged sloped with regard to their oblong cross section towards the blade length 28 as well as towards a blade width 31. The blade width 31 is thereby measured from a leading edge 32 up to a discharge edge 33 of the respective guide blade 14. By contrast, the oblong passage openings 26 in the examples of FIGS. 6 and 7 are aligned parallel to the blade width 31.

FIG. 9 now shows an embodiment, in which a plurality of oblong passage openings 26 are arranged one behind the other in the direction of the blade width 31, which passage openings 26 are arranged in this case, in addition, offset to each other in the direction of the blade length 28. Further, the passage openings 26 are arranged next to each other along the blade length 28, as well as aligned parallel to each other and parallel to the blade width 31. In the perforation 25 shown in FIG. 9, the passage openings 26 have markedly smaller cross sections through which flow is possible than in the embodiments of FIGS. 5 through 8.

FIG. 10 shows an embodiment, in which the passage openings 26 have an oblong cross section and thereby are single-curved. Regardless of the geometry and number of the passage openings 26, FIG. 10 shows, in addition, an embodiment, in which the respective guide blade 14 has a twice-curved course along its blade length 28. As a result of this, the guide blade 14 has an S-shaped course with regard to its blade length 28.

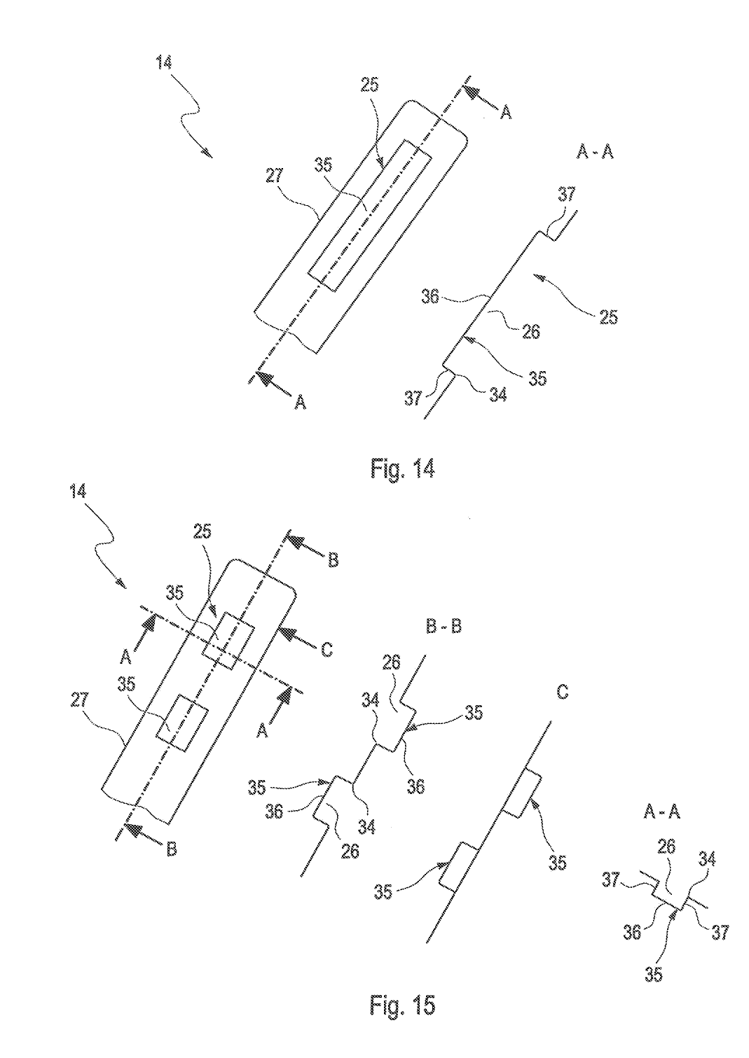

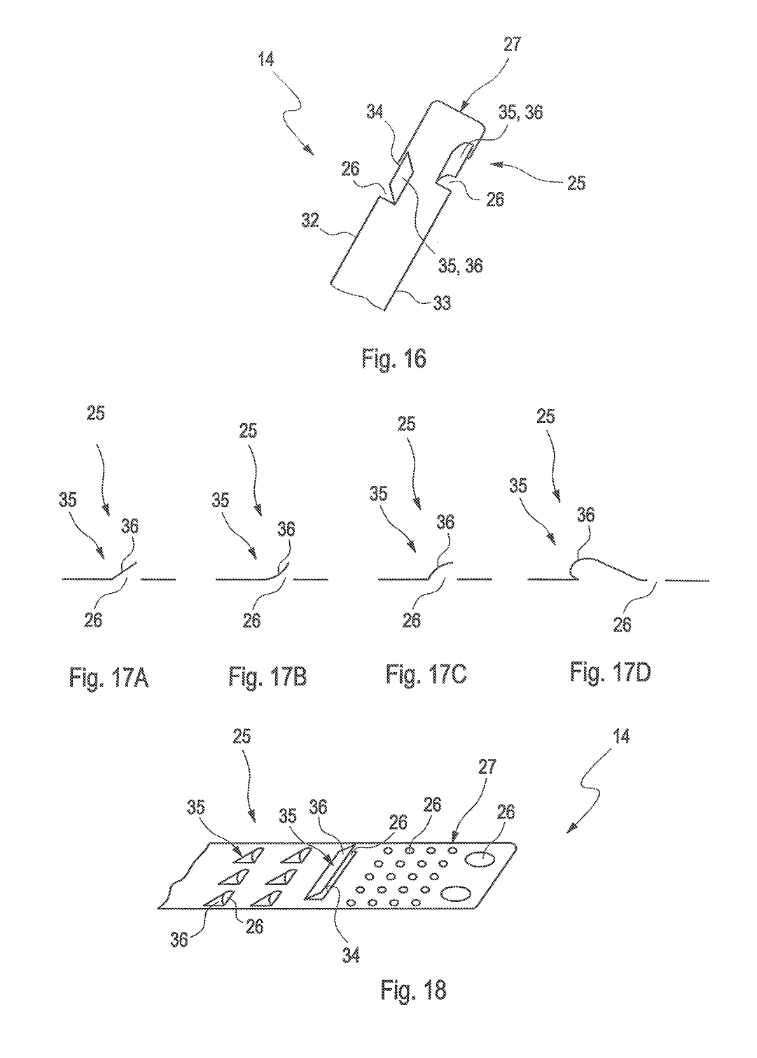

In the embodiments shown in FIGS. 11 and 16, the respective perforation 15 has a plurality of passage openings 26, which are open on the side on the leading edge 32 or on the discharge edge 33 of the respective guide blade 14. As a result of this, the passage openings 26 have an effect on the lateral outer contour 27 of the guide blade 1. In the example of FIG. 14, all passage openings 26 of the perforation 25 are designed as open on the side. Further, all passage openings 26 are oblong in this case and provided with a rectangular cross section. In addition, the passage openings 26 arranged on the leading edge 32 are each arranged parallel to each other and next to each other with regard to the blade length 28. The passage openings 26 provided on the discharge edge 33 are also arranged parallel to each other and next to each other in the blade length 28. Furthermore, the passage openings 26 shown are aligned sloped both towards the blade length 28, i.e., towards the blade width 31. In addition, provisions are thereby made, in addition, for the passage openings 26 of the leading edge 32 to be sloped with regard to the blade length 28 opposed to the passage openings 26 of the discharge edge 33. In particular, the passage openings 26 are arranged in a mirror-symmetrical manner with regard to a central longitudinal axis of the respective guide blade 14, as a result of which the perforation 25 shows a sweepback and the guide blade 14 has a fishbone-like shape. The sweepback of the perforation 25 is aligned toward the blade tip 30 for this.

On the other hand, only a single passage opening 26 open on the side is provided on the leading edge 32 and on the discharge edge 33 each in FIG. 16.

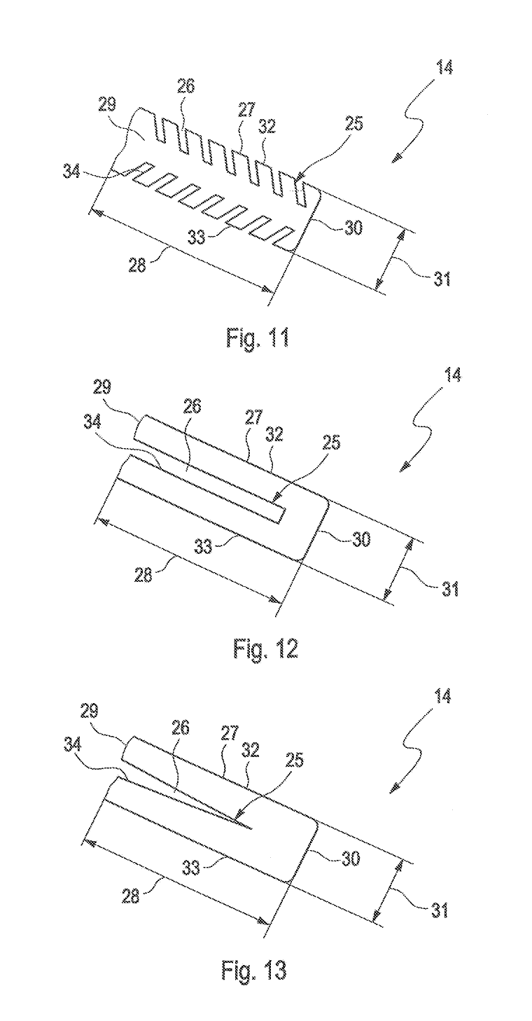

While the examples of FIGS. 5 through 11, 15, 17 and 18 each show perforations 25, which have a plurality of passage openings 26, FIGS. 12 through 14 and 19, 20 show an embodiment each, in which the perforation 25 has only a single passage opening 26 each. At least in the examples of FIGS. 12 through 14, this passage opening 26 is provided with an oblong cross section, which is aligned parallel to the blade length 28. Furthermore, the respective passage opening 26 extends over an essential longitudinal section of the respective guide blade 14. In these examples, the respective passage opening 26 extends over at least 75% of the blade length 28. In the example of FIG. 12, the passage opening 26 has a rectangular cross section, while a triangular cross section is provided in the embodiment shown in FIG. 13. A rectangular cross section is provided again in FIG. 14. In FIGS. 12 and 14, the passage opening 26 has a constant cross section along the blade length 28, while in FIG. 13 the cross section decreases in the direction toward the blade tip 30. In the examples of FIGS. 12 through 14 and 19, 20, the passage opening 26 remains within the lateral outer contour 27 of the associated guide blade 14. In another embodiment, the passage opening 26 may, on the other hand, be so arranged and/or so dimensioned that it is open on the side at the blade tip 30, as a result of which the guide blade 14 is quasi divided in the area of this passage opening 26.

In the embodiments of FIGS. 5 through 13, the passage openings 26 are each equipped with an opening edge 34, which is detached along is entire circumferential extent (circulation). In the embodiments of FIGS. 5 through 10, 12 and 13, in which the passage openings 26 are arranged within the outer contour 27, the respective circulation of the opening edge 24 is closed, while the circulation in the embodiment shown in FIG. 11, in which the passage openings 26 are open on the side at the outer contour 27, is interrupted in each case by the opening on the side of the respective passage openings 26.

In the embodiments of FIGS. 14 through 20, the perforation 25 may have at least one passage opening 26, whose opening edge 34 is connected with a tilting device 35 along a circulation section. In the embodiments of FIGS. 16 through 18, this tilting device 35 is arranged sloped towards an area of the respective guide blade 14 adjacent thereto. Thereby, the respective tilting device 35 brings about a covering of at least one part of the respective passage opening 26. In FIGS. 16 through 18 in the rectangular passage opening 26, three consecutive, linear circulation sections each form a free opening edge 34, while the remaining fourth, linear circulation section is then connected with the tilting device 35, as a result of which the respective tilting device 35 forms a wing 36. The tilting device 35 advantageously forms a free-cut and tilted area of the guide blade 14 in the creation of the respective passage opening 26. Thus, the respective tilting device 35 is formed integrally in one piece with the guide blade 14.

In FIGS. 14 through 20, provisions are made for the perforation 25 to have at least one passage opening 26 with an opening edge 34, which is connected with a tilting device 35 along at least one circulation section, which tilting device 35 at least partly covers the associated passage opening 26 and/or is arranged sloped and/or offset towards an area of the guide blade 14 adjacent thereto.

In FIGS. 14 and 15, provisions are made for at least one such tilting device 35 to have a central area 36 and two lateral areas 37, whereby the central area 36 extends essentially parallel to the respective guide blade 14 and is connected via the two lateral areas 37 with the respective guide blade 14.

On the other hand, in FIGS. 17 and 18, provisions are made for at least one such tilting device 35 to be designed as a wing 36, which is characterized in that it is connected only on one side with the respective guide blade 14, while it is otherwise arranged detached to the respective guide blade 14. These wings 36 may thereby be integrated into the outer contour 27 as in FIG. 16, such that their passage openings 26 are open on the side. Likewise, a distance to the outer contour 27 may be maintained in another embodiment. Two different geometries for the wings 36 are shown in FIG. 16. FIG. 17 shows other variants A, B, C and D for the geometric shape of such wings 36. Thus, FIG. 17A shows a wing 36 with a linear profile. FIG. 17B shows a wing 36 with a concave bent profile in the tilting direction. FIG. 17C shows a wing 36 with a convex bent profile in the tilting direction. FIG. 17D shows, on the other hand, a wing 36 with an aerodynamically shaped profile, especially a drop profile.

FIG. 18 shows, in an exemplary manner, an embodiment, in which the formation of the perforation 25 by means of a plurality of various passage openings 26 with tilting devices 35 (left half in FIG. 18) and without tilting devices 35 (right half in FIG. 18), which differ from each other, moreover, by different geometries and cross sections.

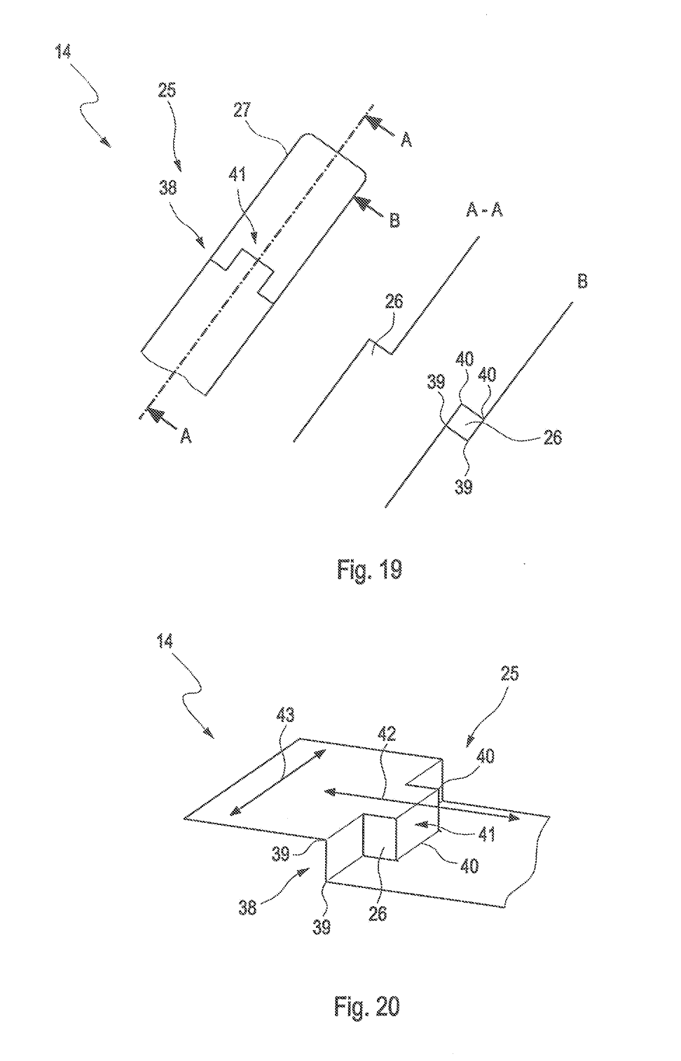

FIGS. 19 and 20 show another embodiment for a special perforation 25, in which the guide blade 14 is equipped with a step 38, which is formed by means of two bending edges 39. In the area of the perforation 25 are provided two other bending edges 40, which are arranged offset to the above-mentioned bending edges 39 in a blade longitudinal direction 42, which runs parallel to the blade length 28 and in which the guide blade 14 is bent in the opposite direction. Accordingly, the tilting device also forms a step 41, which is arranged offset in the blade longitudinal direction 42 to the step 38 of the guide blade 14. As a result of this, two open cross sections, spaced apart from one another, which make possible a lateral inflow and lateral outflow of the exhaust gas, are formed in a blade transverse direction 43, which extends parallel to the blade width 31.

Even though in the preferred embodiment shown here the mixer is designed as a shaped sheet metal part, it may also be designed as a cast part or a sintered part in another embodiment. The respective perforation 25 is then advantageously worked in later.

While specific embodiments of the invention have been shown and described in detail to illustrate the application of the principles of the invention, it will be understood that the invention may be embodied otherwise without departing from such principles.

What is claimed is:

1. A static mixer for an exhaust system for mixing a reducing agent with an exhaust gas flow, the static mixer comprising:
a plurality of guide blades for deflecting the exhaust gas flow, wherein at least one of the guide blades comprises a perforation through which the exhaust gas flows.

2. A static mixer in accordance with claim 1, wherein the perforation comprises a plurality of passage openings, which passage openings are arranged within a lateral outer contour of the respective at least one of the guide blades.

3. A static mixer in accordance with claim 2, wherein the passage openings comprise an oblong cross section and are arranged parallel to each other and next to each other along a blade length, measured from a blade footing to a blade tip, of the respective at least one of the guide blades.

4. A static mixer in accordance with claim 1, wherein the perforation comprises at least one passage opening, which is open on a side at a leading edge or at a discharge edge of the respective at least one of the guide blades.

5. A static mixer in accordance with claim 1, wherein the perforation comprises a plurality of passage openings, which are open on a side at a leading edge or at a discharge edge of the respective at least one of the guide blades, whereby the passage openings open on the side are oblong and are sloped towards a blade length of the respective at least one of the guide blades as well as towards a blade width of the respective at least one of the guide blades.

6. A static mixer in accordance with claim 1, wherein the perforation is formed from a single passage opening.

7. A static mixer in accordance with claim 6, wherein the passage opening is arranged within a lateral outer contour of the respective at least one of the guide blades.

8. A static mixer in accordance with claim 1, wherein the respective at least one of the guide blades has a single- or multi-curved course along a blade length thereof.

9. A static mixer in accordance with claim 1, wherein the perforation comprises at least one passage opening with an opening edge, which is detached along an entire circulation thereof.

10. A static mixer in accordance with claim 1, wherein the perforation comprises at least one passage opening with an opening edge, which opening edge is connected along at least one circulation section with a tilting device, which at least partly covers the associated passage opening and/or is arranged sloped and/or offset towards an area of the guide blade adjacent thereto.

11. A static mixer in accordance with claim 10, wherein the respective tilting device is a free-cut and tilted area of the respective at least one of the guide blades for producing the respective passage openings with a displacement of the area to a tilted position.

12. A static mixer in accordance with claim 10, wherein the at least one such tilting device has a central area and two lateral areas, whereby the central area extends essentially parallel to the respective at least one of the guide blades and is connected with the respective at least one of the guide blades via the two lateral areas.

13. A static mixer in accordance with claim 10, wherein the at least one tilting device is designed as a wing, which wing is connected with the respective at least one of the guide blades only on one side and is arranged otherwise detached in relation to the respective at least one of the guide blades.

14. A static mixer in accordance with claim 10, wherein:
the respective at least one of the guide blades has a step in a longitudinal direction of the blade; and
the at least one tilting device is formed by a step, which step is spaced apart from the step formed in the respective at least one of the guide blades.

15. An exhaust system for an internal combustion engine, the exhaust system comprising:
an injector for introducing a liquid reducing agent into an exhaust gas flow; and
at least one static mixer arranged downstream of the injector with regard to the exhaust gas flow, the at least one static mixer comprising:
a plurality of guide blades for deflecting the exhaust gas flow, wherein at least one of the guide blades comprises a perforation through which the exhaust gas flows.

16. An exhaust system in accordance with claim 15, wherein the perforation comprises a plurality of passage openings, which passage openings are arranged within a lateral outer contour of the respective at least one of the guide blades.

17. An exhaust system in accordance with claim 15, wherein the perforation comprises at least one passage opening, which is open on a side at a leading edge or at a discharge edge of the respective at least one of the guide blades.

18. An exhaust system in accordance with claim 15, wherein the perforation comprises a plurality of passage openings, which are open on a side at a leading edge or at a discharge edge of the respective at least one of the guide blades, whereby the passage openings open on the side are oblong and are sloped towards a blade length of the respective at least one of the guide blades as well as towards a blade width of the respective at least one of the guide blades.

19. An exhaust system in accordance with claim 15, wherein the perforation is formed from a single passage opening arranged within a lateral outer contour of the respective at least one of the guide blades.

20. An exhaust system in accordance with claim 15, wherein the perforation comprises at least one passage opening with an opening edge, which opening edge is connected along at least one circulation section with a tilting device, which at least partly covers the associated passage opening and/or is arranged sloped and/or offset towards an area of the guide blade adjacent thereto.
